(19) United States
(12) Patent Application Publication
(10) Pub. No.: US 2008/0190155 A1
(43) Pub. Date: Aug. 14, 2008

(54) Hub Locking Apparatus For Mortise Lock Assembly

(76) Inventor: Gab-Sik Kim, Seoul (KR)

Correspondence Address: BIRCH STEWART KOLASCH & BIRCH, PO BOX 747, FALLS CHURCH, VA, 22040-0747, US

(21) Appl. No.: 11/910,431

(22) PCT Filed: Apr. 10, 2006
(86) PCT No.: PCT/KR2006/001294

§ 371 Date: Oct. 1, 2007

(30) Foreign Application Priority Data
Apr. 18, 2005 (KR) 10-2005-0031850

(51) Int. Cl. E05B 17/00; E05B 9/06

(52) U.S. Cl. 70/431

(57) ABSTRACT

Disclosed is a hub locking apparatus for a mortise lock assembly, in which a motor is driven by an externally input electrical signal to control a locking member that binds a hub and is located to be automatically unlocked in case where the motor is destroyed by fire. In a mortise lock assembly including a hub rotating along with a rotary ring connected to a handle, opening a door by retracting and releasing a latch bolt from a door frame in accordance with rotation of the hub, a hub locking apparatus for the mortise lock assembly comprises a locking member preventing the hub from being rotated when one end is fitted into a groove of the hub and allowing rotation of the hub when the one end is released from the groove, a pivot member joined with the locking member to pivot the locking member, and a weight body rotating the locking member using its weight so that one end of the locking member is detached from the groove of the hub to freely rotate the hub. The locking state is released in case of emergency such as fire so as to allow people to easily evacuate from the emergency.

### TECHNICAL FIELD

The present invention relates to a hub locking apparatus for a mortise lock assembly, and more particularly, to a hub locking apparatus for a mortise lock assembly, in which a motor is driven by an externally input electrical signal to control a locking member that binds a hub and is located to be automatically unlocked in case where the motor is destroyed by fire.

### BACKGROUND ART

A mortise lock assembly is a kind of a door locking apparatus that releases a latch bolt from a locking groove of a door frame by turning a rotary ring or a handle. It is generally accepted that the mortise lock assembly has the most excellent durability. In this respect, it is general that the mortise lock assembly is used for a door having a metal frame in a front door or an office.

Such a mortise lock assembly is disclosed in detail in the Korean Patent Application No. 10-1999-0017399 filed on May 14, 1999 in the name of the applicant of this invention. This mortise lock assembly has a structure that a latch bolt is deeply inserted into a groove of a door frame to ensure locking even without using a dead bolt.

Meanwhile, the conventional mortise lock assembly has been improved to have a structure configured to lock a hub. The improved mortise lock assembly is configured such that a hub is locked if a ring of a locking member is fitted into a groove of the hub and is unlocked if the ring of the locking member is released from the groove of the hub. A plate is fixed to one side of the locking member, and its end is provided to be engaged with a screw of a motor so that the locking member is rotated around a rotary shaft in accordance with the operation of the motor, whereby the ring of the locking member is fitted into or released from the groove of the hub.

The mortise lock assembly is connected with a fire sensor to receive a signal in accordance with the operation of the fire sensor if a fire occurs. If the signal is received, the motor is operated to allow the ring of the locking member to be released from the groove of the hub. However, if the motor and a screw are destroyed by the fire, the locking member may be rotated to lock the hub. In this case, indoor people may fail to quickly evacuate from the fire.

### DISCLOSURE OF INVENTION

### Technical Problem

The present invention has been made to solve the above-mentioned problems occurring in the prior art, and an object of the present invention is to provide a hub locking apparatus for a mortise lock assembly, in which a hub locking member is released if a screw engaged with the locking member is destroyed or causes trouble due to fire.

### Technical Solution

In a mortise lock assembly including a hub rotating along with a rotary ring connected to a handle, opening a door by retracting and releasing a latch bolt from a door frame in accordance with rotation of the hub, a hub locking apparatus for the mortise lock assembly comprises a locking member preventing the hub from being rotated when one end is fitted into a groove of the hub and allowing rotation of the hub when the one end is released from the groove, a pivot member joined with the locking member to pivot the locking member, and a weight body rotating the locking member using its weight so that one end of the locking member is detached from the groove of the hub to freely rotate the hub.

The weight body has a spiral shape and is fixed to a hole formed in the locking member.

### Advantageous Effects

In a hub locking apparatus for a mortise lock assembly according to the present invention, since a weight body is detachably provided in a locking member, the locking state is released in case of emergency such as fire so as to allow people to easily evacuate from the emergency.

### BRIEF DESCRIPTION OF THE DRAWINGS

FIG. 1 is a perspective view illustrating a mortise lock assembly according to the present invention;

FIG. 2 is an exploded perspective view illustrating a mortise lock assembly according to the present invention;

FIG. 3 to FIG. 5 are front views illustrating a mortise lock assembly according to the present invention, wherein FIG. 3 illustrates the state that a hub is locked, FIG. 4 illustrates the state that the hub is released, and FIG. 5 illustrates the state that the hub is operated to retract a latch bolt;

FIG. 6 illustrates the operation state that the inside and the outside of a door are freely changed in accordance with a position of a mortise lock assembly; and

FIG. 7 is a perspective view illustrating a locking member of a mortise lock assembly according to the present invention.

### BEST MODE FOR CARRYING OUT THE INVENTION

Hereinafter, preferred embodiments of the present invention will be described in detail with reference to the accompanying drawings.

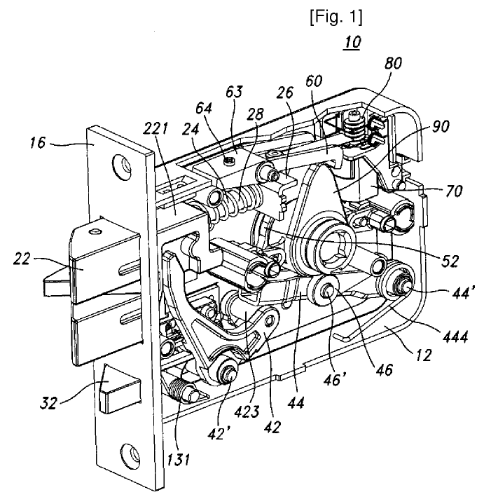

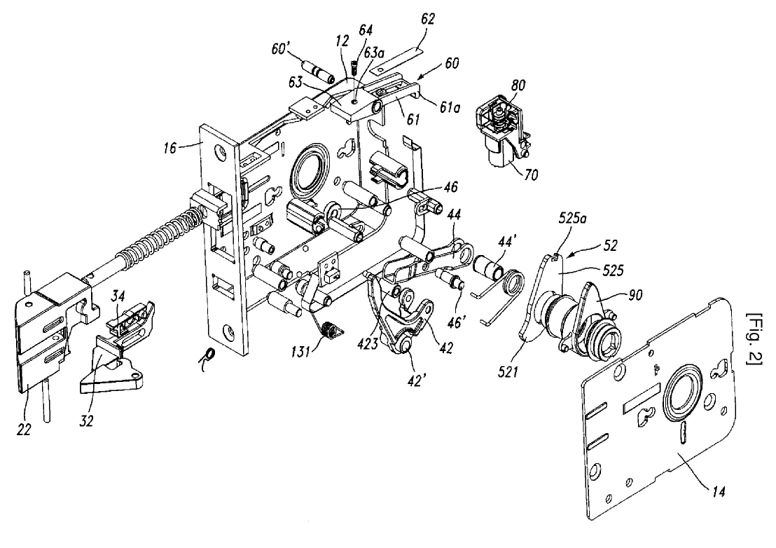

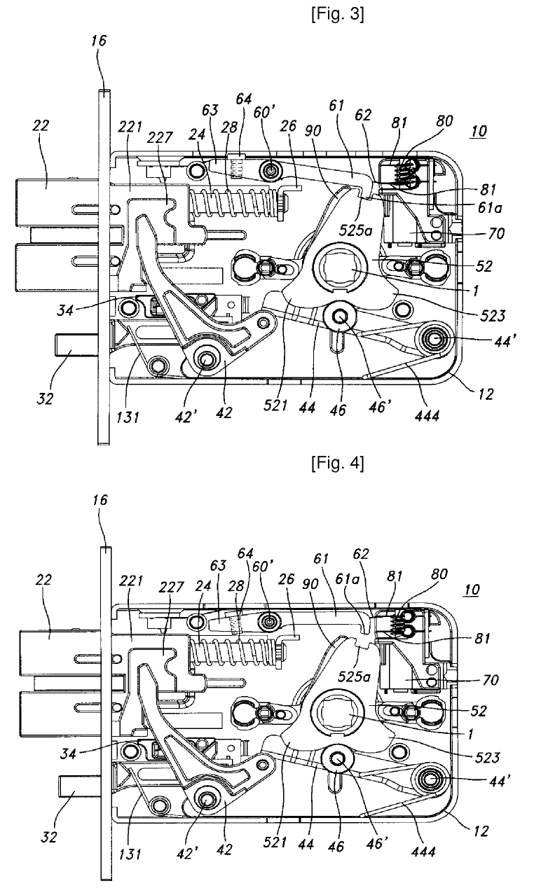

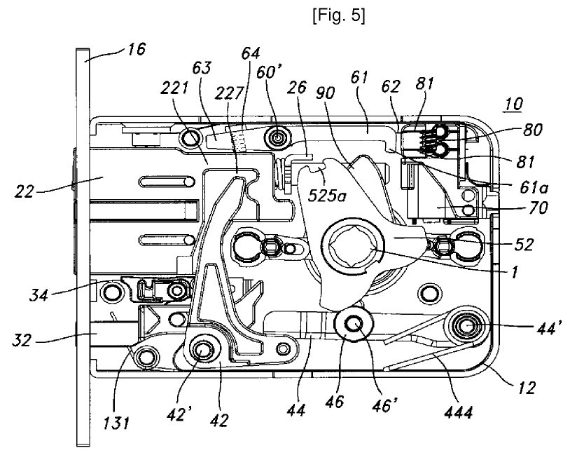

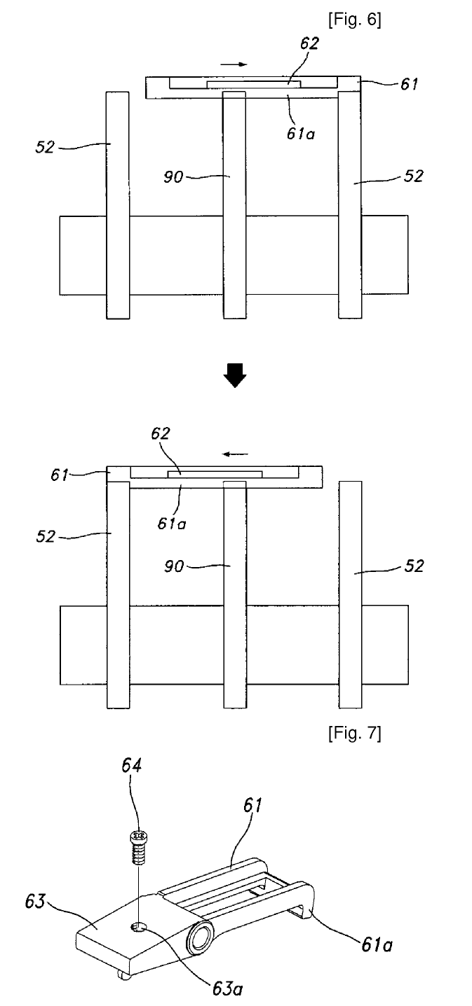

First, FIG. 1 is a perspective view illustrating a mortise lock assembly according to the present invention, FIG. 2 is an exploded perspective view illustrating a mortise lock assembly according to the present invention, FIG. 3 to FIG. 5 are front views illustrating a mortise lock assembly according to the present invention, wherein FIG. 3 illustrates the state that a hub is locked, FIG. 4 illustrates the state that the hub is released, and FIG. 5 illustrates the state that the hub is operated to retract a latch bolt, FIG. 6 illustrates the operation state that the inside and the outside of a door are freely changed in accordance with a position of a mortise lock assembly, and FIG. 7 is a perspective view illustrating a locking member of a mortise lock assembly according to the present invention.

A perspective view illustrating the inside of a case 12 in a state that a cover 14 of a mortise lock assembly according to the present invention is removed is shown in FIG. 1. In the same manner as a conventional mortise lock assembly, as shown in FIG. 1, if a hub 52 is rotated, a pivot member 44 provided with a rotary ring 46 is rotated and one end of the pivot member 44 is pushed to rotate a driving member 42 and at the same time linearly retract a latch bolt 22. A front hub of two hubs 52 is omitted in FIGS. 1 and 2 to avoid any confusion. The hub 52 is well shown in front views of FIGS. 3 to 5. Since a door handle is fitted into a groove 1 of the hub 52, if a user rotates the door handle, the hub 52 is rotated toward a side forced by the user. The hub 52 is designed to arrange the rotary ring 46 between two wings 521 and 523. The hub 52 is rotated around the groove 1 into which the door handle is fitted. Unlike the conventional mortise lock assembly, the hub 52 is provided with a head 525 at the top and the head 525 is provided with a locking groove 525a which is cut. The rotary ring 46 is positioned between the wings 521 and 523 of the hub 52 and upwardly forced by elasticity of a spring 444 provided in a rotary shaft 44 of the pivot member 44. Therefore, the rotary ring 46 is pushed by the wings 521 and 523 to downwardly move along with the pivot member 44 if a rotary force that overcomes the elasticity is given to the hub 52 in a state that the rotary ring 46 is positioned between the wings 521 and 523 by the elasticity. FIG. 5 illustrates the state that the rotary ring 46 is forced to downwardly move.

If the pivot member 44 descends, the end opposite to the rotary shaft 44 of the pivot member 44 descends to push a bushing 423 while rotating around the rotary shaft 44. If the bushing 423 is pushed, the driving member 42 is rotated at a certain angle around a rotary shaft 42. Then, a part of the driving member 42 fitted into a groove 227 of the latch bolt 22 is rotated to push the latch bolt 22 to retract it. As a result, the latch bolt 22 is released from the groove of the door frame so that the door can be opened. A shaft 24 is assembled at the rear of the latch bolt 22 and locked in a shaft support plate 26. The shaft 24 is provided with a spring 28 to provide a force that externally pushes the latch bolt 22.

A trigger bolt 32 is provided below the latch bolt 22 and designed to advance and reverse along with the latch bolt 22 by passing through a front plate 16. The trigger bolt 32 is forced toward the front by a force of a spring 131. A stopper member 34 for stopping the latch bolt from retracting is provided above the trigger bolt 32.

The driving member 42 has a right angled L shape and is rotated around the rotary shaft 42. One end of the driving member 42 is fitted into a groove 227 of a body 221 of the latch bolt 22 to pull the latch bolt 22 while the other end of the driving member 42 is rotated by being pushed by the pivot member 44.

The rotary ring 46 is respectively provided at front and rear sides of the pivot member 44 to respectively correspond to the two hubs 52. The two hubs 52 are provided because the door handle is respectively provided at front and rear sides of the door.

As described above, each hub 52 is provided with the head 525 having the groove 525a, and a locking member 61 serving as a locking means 60 has a ring 61a at one end to be fitted into the groove 525a of the hub 52. The ring 61a is assembled into the assembly to rotate with respect to the rotary shaft 60, and the locking member 61 is provided with a control plate 62 having a thin plate shape. The control plate 62 is designed to be locked in a screw 80 provided in a rotary shaft of a motor 70, and ascends and descends along the screw 80 in accordance with rotation of the motor 70 so that the ring 61a of the locking member 61 is bound to or released from the groove 525a of the hub 52. The motor 70 is supplied with an external power source and operated by an external electrical signal. An electronic key or a smart card may be used to supply the electrical signal to the motor 70.

A stopper 81 of a conducting material is provided at upper and lower ends of the screw 80 so that the control plate 62 is not released from the screw 80. If the control plate 62 of a conducting material adjoins the stopper 81 as the screw 80 is operated, the stopper 81 serves as a switch so as to stop driving of the motor 70 through a circuit.

For example, if the electronic key is used, an electrical signal is applied from the circuit to the motor 70 to drive the motor 70. If a rotary force occurs as the motor 70 is driven, the control plate 62 upwardly moves along the screw 80 so that the ring 61a of the locking member 61 is released from the groove 525a of the hub 52 to open the door. In an opposite case, since the ring 61a is fitted into the groove 525a, the hub 52 is not rotated so as not to open the door. If the control plate 62 adjoins the stopper 81, the motor 70 is stopped.

FIG. 6 is a front view illustrating the operation state that the inside and the outside of the door are freely changed as the locking member 61 moves. Referring to FIG. 6, the locking member 61 moves in left and right directions based on FIG. 6 along the rotary shaft 60 to change the inside and the outside of the door. Since the distance between the two hubs 52 is greater than the width of the locking member 61, the locking member 61 is designed to lock only one of the two hubs 52. Further, since the locking member 61 moves along the rotary shaft 60, the right side becomes the outside if the locking member 61 is directed toward the right side as shown in an upper portion of FIG. 6 while the left side becomes the outside if the locking member 61 is directed toward the left side as shown in a lower portion of FIG. 6.

Referring to FIG. 7, a weight body 64 is provided at an opposite side 63 of the ring 61a around the rotary shaft 60 so that the locking member 61 is released from the hub 52 as shown in FIG. 4 if the screw 80 is destroyed in case of emergency such as fire. In this case, the ring 61a is lifted by the weight body 64 when no force reaches the plate. In other words, the locking member 61 is provided with a screw hole 63a into which the weight body 64 is fitted.

Meanwhile, the weight body 64 has a spiral shape to be easily detached from the screw hole because upper and lower portions are reversed if the mortise lock assembly is provided in an opposite direction. In this case, the mortise lock assembly is provided in a state that the weight body 64 is removed. If the ring 61a becomes a free state, it is released from the hub 52 due to its weight. A reference numeral, which is not described, represents a cam for forcibly releasing the locking member in case of emergency.

### INDUSTRIAL APPLICABILITY

The hub locking apparatus for a mortise lock assembly according to the present invention can usefully be used for a mortise lock apparatus that locks a door.

1. In a mortise lock assembly including a hub rotating along with a rotary ring connected to a handle, opening a door by retracting and releasing a latch bolt from a door frame in accordance with rotation of the hub, a hub locking apparatus for the mortise lock assembly, comprising:
a locking member preventing the hub from being rotated when one end is fitted into a groove of the hub and allowing rotation of the hub when the one end is released from the groove;
a pivot member joined with the locking member to pivot the locking member; and
a weight body rotating the locking member using its weight so that one end of the locking member is detached from the groove of the hub to freely rotate the hub.

2. The hub locking apparatus for the mortise lock assembly as claimed in claim 1, wherein the weight body has a spiral shape and is fixed to a hole formed in the locking member.
